(19) United States
(12) Patent Application Publication
(10) Pub. No.: US 2024/0218535 A1
(43) Pub. Date: Jul. 4, 2024

(54) ELECTROLYSIS PLANT HAVING A PLURALITY OF ELCTROLYSIS CELLS

(71) Applicant: Siemens Energy Global GmbH & Co. KG, München (DE)

(72) Inventors: Marc Hanebuth, Nürnberg (DE); Markus Ungerer, Baiersdorf (DE); Peter Utz, Nürnberg (DE); Richard Wagner, Effeltrich (DE)

(21) Appl. No.: 18/292,364

(22) PCT Filed: May 31, 2022
(86) PCT No.: PCT/EP2022/064726

§ 371 Date: Jan. 26, 2024

(30) Foreign Application Priority Data
Jul. 30, 2021 (EP) 21188722.9

(51) Int. Cl. C25B 9/60; C25B 9/70; C25B 11/077; C25B 11/081

(52) U.S. Cl. CPC C25B 9/60; C25B 9/70; C25B 11/077; C25B 11/081

(57) ABSTRACT

The invention relates to an electrolysis plant having: a plurality of electrolysis cells which are electrically connected in series and are arranged consecutively at least in part in a stacking direction, wherein the series arrangement can be electrically coupled to an electrical power source; a cell supply unit for supplying the electrolysis cells with at least one process fluid for normal operation; and supply lines which are connected to the cell supply unit and to opposite ends of the consecutively arranged electrolysis cells. A material of the supply lines includes metal, and at least one of the supply lines includes an electrical insulating portion having a control electrode which protrudes at least partially into the interior of the electrical insulating portion. The control electrode has a catalyst material and is electrically contacted to a metal pipe section of the supply line at the anode end thereof.

### BACKGROUND

The invention relates to an electrolysis plant having a plurality of electrolytic cells.

Known electrolysis plants exhibit a large number of electrolytic cells which come into operation in connection with the conversion of chemical substances into other chemical substances under the influence of electricity. As a rule, a chemical reaction—that is to say, a transmutation—is brought about with the aid of an electric current.

For instance, hydrogen is generated nowadays by means of proton-exchange-membrane (PEM) electrolysis or by means of alkaline electrolysis. With the aid of electrical energy, these electrolysis plants then produce hydrogen and oxygen from the water fed in.

An electrolysis plant exhibits a large number of electrolytic cells which are arranged adjacent to one another. By means of the electrolysis of water, for instance, water is broken down into hydrogen and oxygen in the electrolytic cells. In the case of a PEM electrolyzer, distilled water is typically fed in as educt on the anode side and is dissociated into hydrogen and oxygen on a proton-permeable membrane (proton-exchange membrane PEM). The water is oxidized to oxygen at the anode. The protons pass through the proton-permeable membrane. Hydrogen is produced on the cathode side. As a rule, the water is conveyed from an underside into the anodic space and/or cathodic space.

In the course of the electrolysis of water, water is broken down into its constituents, namely hydrogen and oxygen, by utilizing the electric current. In principle, however, other initial substances as educts can also be subjected to electrolysis, for instance carbon dioxide or the like.

Ordinarily in this connection it is a question of fluid substances which in an electrolysis plant can be fed via appropriate supply lines to the electrolytic cells in which the actual electrolysis is carried out. The products of electrolysis are frequently likewise in fluid form and are discharged from the electrolytic cells via further supply lines. As a rule, the supply lines are attached to a cell-supply unit which serves for supplying the electrolytic cells with the respective substances, or with at least one operating substance, for their designated operation. The term “supplying” here accordingly means not only a feeding of the operating substance, or of the substance to be electrolyzed, but also a discharging of the respective product of electrolysis—that is to say, it encompasses the feeding of the educt fluid and the discharging of the product fluid that is obtained from the electrochemical conversion process.

Especially the provision of hydrogen proves to be of special interest on an industrial scale, particularly since hydrogen is a versatile energy-carrier. Hydrogen can be made available by an electrolysis plant—also called an electrolyzer—by utilizing electrical energy produced regeneratively. One option for generating hydrogen consists in utilizing an electrolysis plant having electrolytic cells based on proton-exchange membranes (PEM). The principle of a PEM-based electrolysis plant, or of a PEM-based electrolytic cell, is known in the prior art, for which reason we shall refrain from providing further explanatory remarks in this regard. An electrolytic cell for generating hydrogen and oxygen from water is disclosed by DE 10 2011 007 759 A1, for instance. But DE 10 2019 205 316 A1 also describes an appropriate electrolytic cell for energy-efficient production of hydrogen. Furthermore, DE 21 2018 000 414 U1 discloses a hydrogen-generation system.

As a rule, generic electrolysis plants exhibit a plurality of electrolytic cells which ordinarily are electrically connected in series. The series circuit formed by this means is electrically coupled with a source of electrical energy which makes a suitable electrical voltage available, so that the specified process of electrochemical transmutation can be realized by means of the electrolytic cells.

In addition, the electrolytic cells are arranged successively in a stacking direction, so that a cell stack has been formed. By virtue of the stacked arrangement, it is possible that the successively arranged electrolytic cells can be electrically contacted with one another directly, for instance by mechanical compression, so that separate electrical terminals of the electrolytic cells can be largely reduced.

Within the cell stack a manifold is furthermore provided which serves to feed, or to discharge, the at least one operating substance to, or from, the electrolytic cells. The operating substance may, for example, comprise the fluid fed in—for instance, water—and/or the reaction product—for instance, hydrogen and oxygen. As a rule, the cell stack is operated at a certain electrolytic power in such a way that an electric current is as small as possible but an electrical voltage is as high as possible. This is achieved by virtue of a suitable stacking of the electrolytic cells in the cell stack. As a result, electrical voltages at the respective electrolytic cells in the cell stack can be added to produce the cell-stack voltage, while the electrolytic cells connected in series in this way can be operated with a current that is substantially the same.

The electrolytic power for the operation of the electrolysis plant is made available by the energy-source which for this purpose is capable of being attached to respective opposing ends of the cell stack. A large number of electrolytic cells may have been arranged in a cell stack, for instance more than 100 electrolytic cells, in particular several hundred electrolytic cells, but preferentially not more than approximately 400 electrolytic cells. In the course of an electrolysis of water to yield hydrogen and oxygen, an electrical voltage at one of the respective electrolytic cells amounts to approximately 1.5 V to 2.5 V. The electrical voltage at the cell stack results correspondingly from this, so the electrical voltage at the cell stack frequently exceeds 100 V and may even amount to several hundred volts.

Besides the cell stack, the electrolysis plant includes further components—such as, for example, pumps, heat-exchangers, separating vessels—that are required for the designated operation of the electrolysis plant, or of the electrolytic cells. In the present case, these components are combined by the cell-supply unit for the purpose of supplying the electrolytic cells with at least one operating substance for their designated operation.

The cell-supply unit is attached to the electrolytic cells arranged successively in a stacking direction via supply lines which are attached to the opposing ends of the successively arranged electrolytic cells. As a rule, the supply lines have been formed from a material such as metal or the like.

A correspondingly high electrical voltage arises between the ends of the cell stack, or of the successively arranged electrolytic cells. For the supply lines, which, as a rule, have been formed from a metal, it is therefore necessary that they exhibit respective electrical insulating sections that serve to avoid an electrically conductive connection between the ends of the successively arranged electrolytic cells, and consequently between the electrical terminals of the source of electrical energy.

Although the use according to the prior art has proved effective in principle, it has nevertheless turned out that corrosion may occur, in particular, in the region of the region of the supply line adjoining the electrical insulating section, to which a positive electrical potential of the source of electrical energy is applied during designated operation. Oxidative decomposition of the metallic pipe material takes place in this anodic region of the supply line. This is not only damaging for the electrolysis plant as such, but may also result in contaminations of the at least one operating substance, and therefore in malfunctions in the course of the designated operation of the electrolytic cells.

In order to reduce these difficulties, in the prior art it is known to keep the specific electrical conductivity of the water as low as possible and, by virtue of an insulation segment that is as long as possible, or also by virtue of a reduction of the cross-section in the region of the respective insulating section, to inhibit the corrosion kinetically and in this way to extend the effect temporally. However, corrosion cannot in principle be avoided by this means. In particular, the—albeit slight—electrical conductivity of water, which is always present, particularly within the insulation segment constituted by the insulating section, results in stray currents in the water, particularly within the insulating segment. As a result, the problem of corrosion continues to exist, which is disadvantageous for the service life of an electrolysis plant. In addition to a special and elaborate management of water, concepts are furthermore known involving protective electrodes, in order to counteract the corrosion effects such as regularly occur, for instance in feed lines and discharge lines for the electrolyte of an electrolyzer. For instance, in DE 41 36 917 C1 it is proposed to provide in an electrolyzer a few protective electrodes that are connected in electrically conducting manner to a ground-insulated metal bar. By this means, the current that flows from each protective electrode to the metal bar can easily be measured with sufficient accuracy. Hence the functionality of the protective electrode can be checked.

The object underlying the invention is to specify an electrolysis plant that further lessens the aforementioned corrosion problem and is equipped with a protective concept that is improved in comparison with the known solutions.

### SUMMARY

In one embodiment, an electrolysis plant is provided. The electrolysis plant includes a plurality of electrolytic cells which are electrically connected in series and which are at least partially arranged successively in a stacking direction, wherein the series circuit is capable of being electrically coupled with an electrical energy-source and a cell-supply unit for supplying the electrolytic cells with at least one operating substance for designated operation. The electrolysis plant also includes supply lines attached to the cell-supply unit and to opposing ends of the successively arranged electrolytic cells, where a material of the supply lines features metal. At least one of the supply lines exhibits an electrical insulating section with a control electrode, protruding into the interior of the electrical insulating section, with a catalyst material, which is electrically contacted with a metallic pipe section of the supply line on the anodic side thereof.

DETAILED DESCRIPTION In accordance with the invention, this object is achieved by means of an electrolysis plant with a plurality of electrolytic cells which are electrically connected in series and which are at least partially arranged successively in a stacking direction, wherein the series circuit is capable of being electrically coupled with a source of electrical energy, including a cell-supply unit for supplying the electrolytic cells with at least one operating substance for designated operation, and including supply lines attached to the cell-supply unit and to opposing ends of the successively arranged electrolytic cells, wherein a material of the supply lines features metal, and wherein at least one of the supply lines exhibits an electrical insulating section with a control electrode, at least partially protruding into the interior of the insulating section, with a catalyst material which is electrically contacted with a metallic pipe section of the supply line on the anodic side thereof.

Advantageous developments arise by virtue of features of the dependent claims.

The invention already proceeds from the insight that previous operating concepts for electrolysis plants with regard to the avoidance and elimination of degradation phenomena are complex in terms of plant engineering, above all with respect to damaging corrosion effects, and have considerable disadvantages economically. Particularly effective and also sustainable solutions have not been proposed hitherto in conventional approaches. Rather, the problem of corrosion has continued to exist, this being disadvantageous for the service life of an electrolysis plant.

Since during the operation of the electrolysis plant several hundred volts are typically applied across the insulation segment arising by virtue of the insulating section, by reason of the large difference in voltage there is a distinct excess of electrons on one supply line and a corresponding deficiency of electrons on the other. The voltage in this case is so high that, from a thermodynamic point of view, electrode reactions take place. By virtue of a lowering of the specific conductivity of the water, or by virtue of a lengthening or narrowing of the insulation segments, this reaction can, in principle, be slowed down—that is to say, it can be kinetically inhibited—but it can never be prohibited completely, so this is only a makeshift measure. The water within the insulation segment always has a slight conductivity, so stray currents flow in consequence through the operating substance, in particular through the water in the case of the electrolysis of water, in the region of the insulating section of the supply line.

On the cathodic side with excess of electrons, water is dissociated, in the course of which hydrogen and hydroxide ions are formed. The hydrogen is present in the form of tiny bubbles, or in dissolved form, and is transported away with the water. The quantities produced are so small that no perturbing effects stem from the hydrogen. The hydroxide ions are to be found in the water in dissolved form and, on account of their negative charge and the direction of the prevailing electrical field, have a tendency to migrate from the cathodic side of the supply line in the direction of the insulating section and the adjoining anodic side of the supply line situated downstream of said section.

On the anodic side, on the other hand, the metallic pipe material of the supply line is decomposed oxidatively. In the case of a supply line consisting of high-grade steel, for instance, metallic iron Fe goes into solution as Fe³⁺ as a result of the anodic corrosion, so significant quantities of Fe³⁺ foreign ions are introduced into the water over time. But other species may also be formed—for example, rust which remains locally on the surface and is recognizable by its characteristic brown color. In addition to iron, however, further metals that are present in the steel may also be dissolved and may thereby form damaging cations. On account of their positive charge, these metal cations have a tendency to migrate in the opposite direction to the hydroxide, resulting in further disadvantageous consequential phenomena by virtue of the formation of so-called rouging. The term “rouging” means ultrafine ferriferous particles that are distributed in the pipelines and components of the electrolysis system.

It has also been recognized to be a major disadvantage that metal ions from the oxygen side can get into the membrane electrode units (MEAs) and accumulate therein. Amongst other things, this process results in higher cell voltages. Moreover, MEA-damaging mechanisms are associated with these metal ions. For instance, H₂O₂ formed on the electrodes can, upon contact with metal ions, be converted into radicals that can chemically attack the membrane structure of the MEAs and impair the service life in this way.

This is where the present invention begins in purposeful manner, by the formation and release of a critical foreign-ion concentration of damaging cations in the supply line already being avoided as far as possible in the region of the insulation section, and by appropriate precautions being taken. With the control electrode provided for this purpose, partially protruding into the interior of the insulating section and exhibiting a catalyst material, it is ensured that a stray current, in particular on the anodic side of the insulating section, does not drain away via the metallic pipe material of the supply line but, instead of this, drains away in purposeful manner via the control electrode which acts catalytically. Anode-side corrosion is consequently suppressed, since no damaging metal cations, such as Fe³⁺ for instance, from the ferriferous material of the supply line are able to go into solution. The damaging processes, in particular those processes on the anodic side, as set forth above, can be suppressed very efficiently and, above all, sustainably with the control electrode with the catalyst material, and can be practically avoided completely. The service life of the electrolysis plant is advantageously increased. The insulating section has been constructed in tubular form and has been inserted into the supply line tightly in terms of fluid mechanics, for instance as a connecting flange. The operating substance in the supply line exhibiting the insulating section is consequently capable of being conducted through the insulating section in fluid-tight manner. The insulating section exhibits an axial enlargement in the axial direction—that is to say, in the direction of flow of the operating substance. The control electrode partially protrudes into the interior of the insulating section. Depending upon the configuration and the achievable control efficiency for the purpose of corrosion-reducing stray-current absorption, the control electrode may protrude approximately between 30% and 70%, preferentially approximately 40% to 60%, into the interior of the insulating section in the axial direction, measured from the anodic side of the insulating section. The control electrode has been electrically contacted with the metallic pipe section of the supply line on the anodic side and has been set to an appropriate potential, so that the release of metal cations, for instance Fe³⁺, from the metallic pipe material of the connecting line has already been efficiently avoided in the anodic section of the supply line, and a protection against corrosion has been achieved. The control electrode acts electrically and catalytically and, by reason of its dimensions and geometry with a correspondingly low flow resistance for a fluid flowing around, does not impair, or does not appreciably impair, the conveying of the operating substance within the supply line. The catalyst material has been applied on the base body of the control electrode. The catalyst material of the coating has been chosen in such a way that it favors, for instance, the electrochemical decomposition of water into protons and oxygen. Besides the positioning and arrangement of the control electrode in the insulating section, the catalytic action thereof by virtue of the catalyst material in combination ensures a particularly efficient protection against corrosion.

In one embodiment of the electrolysis plant, the control electrode protrudes between 30% and 70%, in particular between approximately 40% to 60%, into the interior of the insulating section in the axial direction, measured from the anodic side of the insulating section.

It has been ascertained that the axial positioning of the control electrode with the catalyst material within the insulating section influences the protective effect and the control efficiency of the protection against corrosion. This working region for the axial position of the control electrode within the insulating section has proved to be particularly effective for the purpose of corrosion-reducing stray-current absorption, depending upon the configuration and the achievable control efficiency. A particularly effective capture of electrons and also an anode-side drainage of the electrons through the control electrode into the anode-side metallic pipe material are favored thereby.

According to a particularly advantageous development of the electrolysis plant, it is proposed that the electrolytic cells are arranged in at least two partial stacks, wherein each of the at least two partial stacks is connected to the cell-supply unit by means of at least one first supply line, attached to the cell-supply unit and to a first end of the respective partial stack, and by means of at least one second supply line attached to the cell-supply unit and to a second end, situated opposite the first end in the stacking direction, of the respective partial stack, wherein that first supply line which is attached to the first end of that partial stack which is capable of being coupled with a negative electrical potential of the source of electrical energy is attached in electrically conducting manner to the cell-supply unit, and all the other supply lines exhibit respective electrical insulating sections, a plurality of the insulating sections exhibiting a respective control electrode protruding at least partially into the interior of the insulating section.

Advantageously, even all of the insulating sections are equipped as needed with a respective control electrode protruding at least partially into the interior of the insulating section.

Therefore a particularly comprehensive protection against corrosion in the electrolysis plant is obtained, since damaging stray currents are drained away in a plurality of electrical insulating sections—if need be, even in each of the electrical insulating sections—to the extent that these corrosion effects are to be feared. The release of metal cations is consequently suppressed efficiently and sustainably, even in a complex electrolysis plant having several partial stacks of electrolytic cells. The corrosion-protection concept of the invention is therefore flexibly applicable and adaptable also in electrolysis plants on an industrial scale having great electrolytic power. The corrosion-prone electrical insulating sections of the supply lines, in particular on the side acting anodically, are equipped in purposeful manner with a respective control electrode protruding at least partially into the interior of the insulating section. The control electrode protrudes partially into the interior of the insulating section. Depending upon the configuration and the achievable control efficiency for the purpose of corrosion-reducing stray-current absorption, the control electrode may protrude approximately between 30% and 70%, preferentially approximately 40% to 60%, into the interior of the insulating section in the axial direction. This can be flexibly configured in the given case, according to the local geometry in the region of the connecting line and insulating section, and according to the requirements as regards the protection against corrosion.

By way of material for the electrical insulating section, a synthetic substance, a ceramic, but also a metal oxide—such as, for example, titanium dioxide, aluminum oxide and/or the like—may, for instance, have been provided. In addition, a composite material may also have been provided which, for instance, may have been formed from a synthetic substance which, for instance, may be fiber-reinforced. Of course, almost any combinations of these may also have been provided, which have preferentially been chosen in such a manner that a chemical reaction with the operating substance to be fed in the given case is substantially avoided.

The material of the supply line features at least metal. The metal may be, for example, a steel, in particular a high-grade steel. In addition, a different metal—for instance, titanium or the like—may of course also find application. Of course, corresponding metal alloys may also have been provided.

The source of electrical energy of the electrolysis plant may be, for instance, any voltage-source or current-source that is able to make sufficient power available for the implementation of the electrolysis by the electrolytic cells. An electrolytic power may have been determined at a specific surface-current density as a function of the dimensions of the respective electrolytic cell, in particular the dimensions of its electrolytically active regions.

The supply lines exhibit a passage opening with a suitable inside diameter, or cross-section, in order to be able to conduct the respective operating substance to the electrolytic cells with as little loss as possible, and/or to be able to discharge it from the respective electrolytic cells, or from the partial stacks, with as little loss as possible.

In a further embodiment of the electrolysis plant, the control electrode has been arranged in such a manner that during designated operation when the operating substance is being supplied a stray current in the supply line is capable of being drained away via the control electrode by virtue of the anodic action thereof.

The anode-side electrical linkage and action of the control electrode is particularly efficient and therefore advantageous, since in the region of the anodic side of the supply line adjoining the insulating section the release of metal cations by reason of stray currents is particularly corrosive and therefore damaging.

In one embodiment, the control electrode is configured in wire-like, rod-like or grid-like manner. In principle, diverse geometrical configurations and material compositions are flexibly available. Constructing the control electrode from a metal wire and/or with a rod-like or grid-like geometry is particularly advantageous by reason of the good local adaptability in the installed state and by reason of the low flow resistance that the control electrode offers in the interior of the insulating section to the operating substance being conveyed in the supply line during operation. It is also possible that the control electrode has been configured from a cylindrical or cup-shaped wire mesh. By this means, a larger effective surface area of the control electrode across the internal cross-section of the supply line is made available, in order to drain away practically completely, or to prohibit, damaging corrosion-promoting stray currents. At the same time, by virtue of this geometry a sufficiently low flow resistance of the electrical control electrode to the conveying of the operating substance in the interior of the supply line is ensured.

Moreover, the control electrode preferably exhibits a carrier metal of high conductivity—in particular, titanium—coated with the catalyst material.

For instance, the base body of the control electrode may exhibit, or be composed of, an oxidation-resistant material of high conductivity. Titanium preferentially suggests itself here. For instance, a titanium expanded metal may also serve as carrier or base body of the control electrode or, as described, as the rod-like or wire-like configuration. The catalyst material has been applied onto this base body. The catalyst material of the coating has preferably been chosen in such a way that it favors, for instance, the electrochemical decomposition of water into protons and oxygen.

In one embodiment, the catalyst material exhibits an oxide of a noble metal. More preferably, the coating of the control electrode contains a catalyst material that exhibits a mixed oxide including iridium and/or ruthenium.

Consequently, a titanium-based control electrode in the form of a titanium/mixed-oxide anode may, for instance, find application, with a carrier consisting of titanium which is activated with a layer of mixed oxide. The layers consist predominantly of oxides of a noble metal pertaining to the platinum-group metals with other dopants, so that so-called mixed-metal-oxide anodes (MMO) have been formed.

Depending upon the requirement, an MMO anode, such as are used for an electrophoretic coating method, may also find application as anodically acting control electrode in the insulating section of the electrolysis plant. These anodes are preferably based on an iridium/tantalum activation, 12.5 g of iridium per square meter, such as titanium expanded metal type A, for instance with a fastening element, realized for instance in the form of a welded-on hook, for fastening and electrical contacting of the control electrode on the anodic side of the supply line.

By way of material for the electrical insulating section, a synthetic substance, a ceramic, but also a metal oxide—such as, for example, titanium dioxide, aluminum oxide and/or the like—may, for instance, have been provided. In addition, a composite material may also have been provided which, for instance, may have been formed from a synthetic substance which, for example, may be fiber-reinforced. Of course, almost any combinations of these may also have been provided which have preferentially been chosen in such a manner that a chemical reaction with the operating substance to be fed in the given case is substantially avoided.

The material of the supply line features at least metal. The metal may be, for example, a steel, in particular a high-grade steel. In addition, a different metal—for instance, titanium or the like—may also find application. Of course, corresponding metal alloys may also have been provided.

In one embodiment of the electrolysis plant, the respective ends, facing toward the respective insulating sections, of the partial stacks are electrically insulated with respect to the electrolytic cells.

As a result, it can be ensured that the corrosion effect is largely avoided in the region between the insulating section and the respective end of the partial stack. The effect of the invention can thereby be improved further.

In a one embodiment of the electrolysis plant, a voltage-source has been provided which is attached to the cell-supply unit, so that a negative electrical potential with respect to the ground potential is capable of being applied to the cell-supply unit.

By this means, the cell-supply unit in the electrolysis plant is electrically grounded at least indirectly. By virtue of the grounding, the cell-supply unit with the supply lines electrically coupled with the cell-supply unit can be set to a predetermined reference potential. By this means, the negative potential of the source of electrical energy, which is electrically coupled with the cell-supply unit via the supply lines, may also have been grounded, likewise at least indirectly, at the same time. Unlike in the prior art, the cell stack formed from the partial stacks is consequently at a defined electrical potential with respect to the ground potential and is consequently no longer subject to floating potential. Consequently, a defined difference in electrical potential, or electrical voltage, can be obtained at the respective electrical insulating sections by this means. This permits the reliability of the functioning of the invention to be improved further.

Moreover, in an advantageous realization it is proposed that the grounding exhibits a sacrificial anode and/or a voltage-source by means of which a negative electrical potential with respect to the ground potential is capable of being applied to the cell-supply unit. As a result, a “cathodic protection against corrosion” can be obtained. If a voltage-source is being utilized, the negative electrical potential of the voltage-source may have been electrically connected to the cell-supply unit and to the supply lines attached thereto. The negative electrical potential of the voltage-source is preferentially grounded appropriately at the same time. For good functioning of the protection against corrosion realized in this way, the invention may provide that the voltage-source makes available an electrical voltage within a range from approximately −2 V to approximately 0 volt in relation to the ground potential. It proves to be particularly advantageous if this electrical voltage has been chosen within a range from approximately −1 V to approximately −0.8 V. With an electrical voltage chosen within this range, a corrosion of high-grade steel, for example, can be avoided even under maritime conditions, in particular in offshore applications. In particular, an external corrosion phenomenon can be diminished or prevented by this means.

In one embodiment, the partial stacks have been attached to the cell-supply unit in parallel by methods of supply engineering. In this way, a good supply of the at least one operating substance for the partial stacks can be obtained. The supplying may encompass a feeding or a discharging of the operating substance, or of substances generated during the electrolysis.

In order equally to diminish, or to avoid, an internal corrosion phenomenon, the invention may preferentially provide that a further electrode in the manner of a counter-electrode for the cathodic protection against corrosion is arranged in the region of the cell-supply unit. The term “internal corrosion phenomenon” relates, in particular, to corrosion effects within the electrolysis plant, in particular within the cell-supply unit. For instance, in this regard it may be a question of a titanium electrode, or titanium anode, which may have been coated with a mixed oxide. The anode that has been formed in this way is preferentially arranged in a liquid phase of an oxygen-separating vessel of the cell-supply unit.

Particularly advantageously, the partial stacks have been attached to the cell-supply unit in parallel by methods of supply engineering. In this way, a good supply of the at least one operating substance for the partial stacks can be obtained. The supplying may encompass a feeding or a discharging of the operating substance, or of substances generated during the electrolysis.

The features and combinations of features mentioned in the description in the foregoing, as well as the features and combinations of features mentioned below in the description of the figures and/or shown solely in the figures, are capable of being used not only in the combination specified in the given case but also in other combinations, without departing from the scope of the invention.

In the embodiment examples elucidated in the following it is a question of preferred embodiments of the invention. The features and combinations of features specified previously in the description, as well as the features and combinations of features mentioned in the following description of embodiment examples and/or shown solely in the figures, are capable of being used not only in the combination specified in the given case but also in other combinations. Consequently, realizations are also to be regarded as being encompassed or disclosed by the invention that have not been explicitly shown and elucidated in the figures but that are evident from the elucidated embodiments by virtue of separate combinations of features and that are capable of being generated. The features, functions and/or effects presented with reference to the embodiment examples may, by themselves, represent in each instance individual features, functions and/or effects of the invention that are to be considered to be independent of one another and that in each instance also develop the invention independently of one another. Therefore the embodiment examples are also intended to encompass combinations other than those in the elucidated embodiments. In addition, the described embodiments may also be supplemented by further features, functions and/or effects of the invention that have already been described.

### BRIEF DESCRIPTION OF THE FIGURES

In the figures, like reference symbols denote like features or functions.

FIG. 1 shows, in a schematic block representation, an electrolysis plant for the electrolysis of water;

FIG. 2 shows a schematic sectional representation of a supply line of the electrolysis plant according to FIG. 1 in the region of an insulating section;

FIG. 3 shows a schematic sectional representation of a supply line of the electrolysis plant according to FIG. 1 in the region of the insulating section with a control electrode;

FIG. 4 shows a schematic block representation of a further electrolysis plant for electrolyzing water, in which a cell stack has been split into four partial stacks.

### DETAILED DESCRIPTION OF THE FIGURES

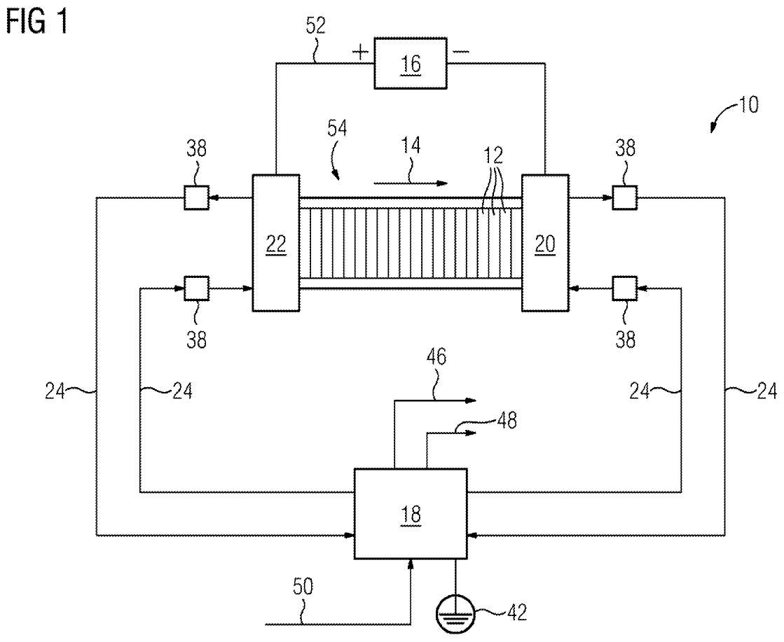

FIG. 1 shows, in a schematic block representation, an electrolysis plant 10 which exhibits a cell stack 54 which exhibits a plurality of electrolytic cells 12 which are arranged successively in a stacking direction 14. In the present case, the electrolytic cells 12 serve to decompose water by electrochemical means into its components—oxygen and hydrogen. The electrolysis plant 10 therefore serves in the present case for generating hydrogen and oxygen from water.

In the present case, the electrolytic cells 12 are arranged directly adjacent to one another, so that respective electrodes of the adjacently arranged electrolytic cells 12 are able to contact one another electrically. In this connection, the invention provides that in each instance an anode of a first of the electrolytic cells 12 electrically contacts a cathode of the second electrolytic cell 12 arranged directly adjacent in each instance. As a result, the electrolytic cells 12 are electrically connected in series.

Via an internal supply structure, not represented in any detail, of the cell stack 54, on the one hand the electrolytic cells 12 are supplied with water to be electrolyzed, and, on the other hand, discharge lines for the substances produced—hydrogen and oxygen—are made available. This supply is designed to be capable of being attached to respectively opposing ends 20, 22 of the cell stack 54.

Furthermore, an electrical energy-source 16, which in the present case makes available a suitable electrical voltage having a suitable electrical power, is attached to the ends 20, 22 via an electrical line 52, so that the electrolytic cells 12 can be supplied with electrical energy sufficiently for designated operation.

The electrolysis plant 10 further includes a cell-supply unit 18 which serves for supplying the electrolytic cells 12, or the cell stack 54, with the respective operating substances which in the present case relate to the feeding of water and the discharging of hydrogen and oxygen. For the discharging of the products, a discharge line 46 for hydrogen and also a further discharge line 48 for the oxygen have been provided in the cell-supply unit 18. For the feed of water as educt of the electrolysis, an appropriate feed pipe 50 for water is attached to the cell-supply unit 18. The cell-supply unit 18 includes, in addition, several components that are required for the designated operation of the electrolysis plant 10, such as, for example, pumps, heat-exchangers, separating vessels and/or the like, which, however, have not been represented in any detail here. The cell-supply unit 18 is connected to the cell stack 54 by methods of supply engineering via supply lines 24 which are attached to the cell-supply unit 18 and to the opposing ends 20, 22 of the cell stack 54. The supply lines 24 consequently couple the supply structure of the cell stack 54 by methods of fluid mechanics. The supply lines 24 in the present case have been formed from a metal such as high-grade steel.

In order to avoid a short circuit between the ends 20, 22 of the cell stack 54 by virtue of the supply lines 24 formed from metal, each of the supply lines 24 exhibits an electrical insulating section 38. By this means, it is guaranteed that the ends 20, 22 have been formed so as to be electrically insulated from the cell-supply unit 18 and therefore also electrically insulated from one another. The supply lines 24 are located outside the cell stack 54.

In the present case, the insulating sections 38 have been formed substantially from an electrical insulating material which may be, for example, a suitable ceramic material or a suitable synthetic substance or composite material.

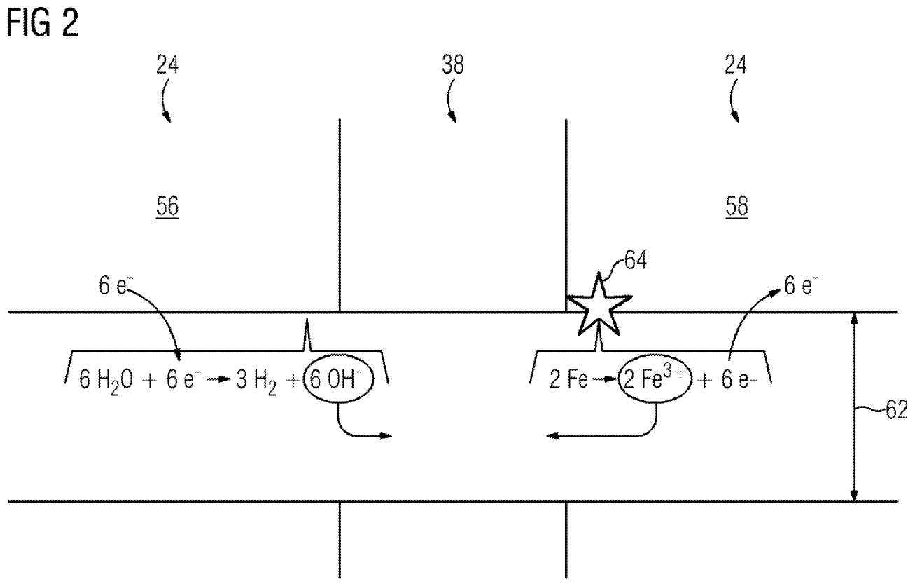

FIG. 2 shows a schematic sectional view of one of the supply lines 24 from FIG. 1 in the region of the insulating section 38. In FIG. 2, the supply line 24 has been represented with a first region 58 which faces toward end 22 of the cell stack 54, whereas an opposing second region 56 faces toward the cell-supply unit 18. The regions 56 and 58 are electrically separated from one another by the insulating section 38. This arrangement is designed to be fluid-tight overall and has a substantially constant inside diameter 62 through which the corresponding fluid can be conducted, which in this case is water.

By reason of the electrical voltage applied to the electrical insulating section 38, corrosion takes place in a region 64. This may be regarded as being due to the fact that, as a result of uptake of electrons from the metal of the wall of the supply line 24 into the water that is flowing within the inside diameter 62, negative hydroxide ions are formed in the region of a transition from region 56 to the electrical insulation section 38, which, by reason of the electrical field, are conducted to region 58 and react electrochemically there with the metal of the wall of the supply line 24, as represented in FIG. 2. As a result, the wall of the supply line 24 corrodes in this region 64. This is undesirable and, for the operation of the electrolysis plant, disadvantageous for the service lives.

For this type of corrosion, it is to be borne in mind that a DC voltage within a range of several hundred volts may, as a rule, be applied across the electrical insulating sections 38 during designated operation. As a result, in the region of the electrical insulating section 38 an excess of electrons may arise in region 56, and a deficiency of electrons may arise in region 58. By reason of the magnitude of the electrical voltage at the electrical insulating section 38, from a thermodynamic point of view electrode reactions take place, as explained previously. Although the corrosion effect can be temporally extended—that is to say, kinetically inhibited—by reduction of the electrical voltage, it cannot thereby be prohibited completely. A lengthening of the insulation segment by means of the electrical insulating section 38, or a reduction in the inside diameter 62, can merely inhibit the corrosion effect with regard to its action, but cannot avoid it.

In region 56, the hydrogen that is formed in this process may be present dissolved in the water or may be present in the form of tiny bubbles and can be transported away with the water. As a rule, the quantities produced are so small that no perturbing effects stem from the hydrogen itself.

With respect to the hydroxide ions which are present in the water in dissolved form, however, this is not the case. On account of their negative charge and the direction of the electrical field in the region of the electrical insulating section 38, they have a tendency to migrate from region 56 to region 58. In this region 58 the metallic material of the supply line 24 is then decomposed oxidatively. In FIG. 2, this decomposition is represented for the case where the supply line 24 has been formed from high-grade steel. However, this effect is not limited to steel but may occur with almost any other metallic material.

Besides the releasing of iron as cation Fe³⁺, however, further metals such as may be present in the steel may also be dissolved. Further cations may be formed in this process. On account of their positive charge, the metal cations have a tendency to migrate in the opposite direction to the hydroxide ions. This may have the result that so-called rouging is formed from the metal cations, particularly if they are iron ions, and from the hydroxide ions. The term “rouging” means ultrafine ferriferous particles which may be distributed in the supply lines 24 and in the components of the electrolysis plant 10. They can be observed, above all, in the supply lines 24 in which hydrogen is likewise being conducted. If this rouging gets into the oxygen-conducting part of the electrolysis plant 10, the rouging may dissolve again, forming ions.

Amongst other things, cations from the oxygen side can then get into the electrolytic cells 12 and accumulate therein. This process may result in higher cell voltages and therefore in declining efficiency of the electrolysis plant 10. Moreover, damaging mechanisms for the electrolytic cells 12 may be associated with these cations. For instance, hydrogen peroxide that has been formed on the electrodes can, upon contact with metal ions, be converted into radicals that can chemically attack a membrane structure of the electrolytic cells 12 and in this way impair the service life of the electrolytic cells 12 disadvantageously.

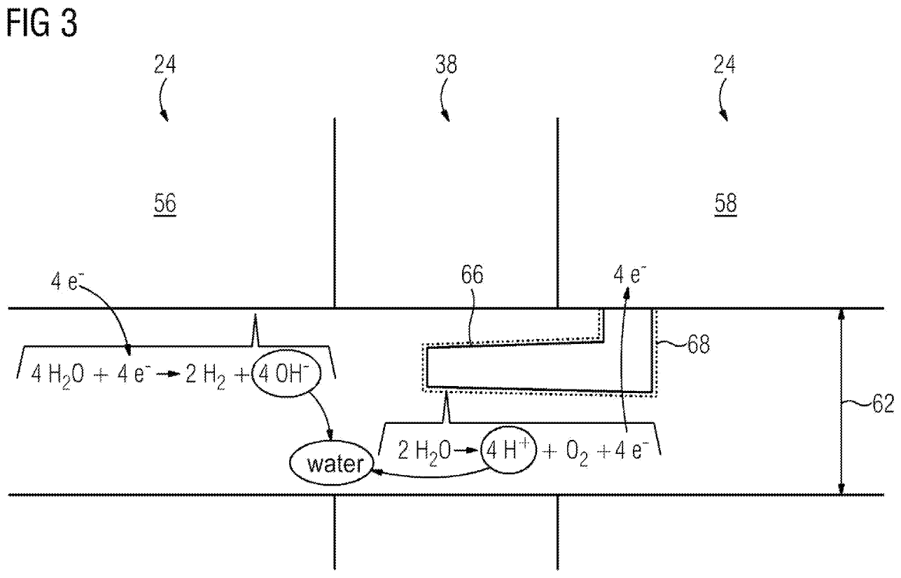

FIG. 3 shows a schematic sectional view of a supply line 24 in which the disadvantageous corrosion effect in the region of the insulating section 38, which was elucidated with reference to FIG. 2, is avoided very effectively and sustainably. The supply line 24 shown in FIG. 3 is part of an electrolysis plant 10 roughly corresponding to FIG. 1 with an insulating section 38. In FIG. 3, the supply line 24 has been represented with a first region 58 which faces toward end 22 of the cell stack 54, whereas an opposing second region 56 faces toward the cell-supply unit 18. The regions 56 and 58 are electrically separated from one another by the insulating section 38. This arrangement is designed to be fluid-tight overall and has a substantially constant inside diameter 62, through which the corresponding fluid, the operating substance, can be conducted in the axial direction in the interior of the supply line. The fluid, or the operating substance, in this case is water for the electrolysis of water.

The supply line 24 exhibits an electrical insulating section 38 with a control electrode 66 protruding at least partially into the interior of the electrical insulating section 38. The control electrode 66 is realized as a wire loop with a base material consisting of titanium. By this means, a high electrical conductivity is afforded. The control electrode 66 has furthermore been coated with a catalyst material 68 which exhibits a mixed oxide including iridium and/or ruthenium. The catalyst material 68 has been applied onto the titanium base body, so that a catalytically acting layer has been formed on the control electrode 66. Via the first region 58 of the supply line 24, constituting the anodic side, the control electrode 66 is electrically contacted and is set to an appropriate positive potential, so that stray currents are capable of being drained away.

The control electrode 66 has been arranged and oriented in such a manner that during designated operation when the operating substance—in the present case, water—is being supplied for the electrolysis of water an undesirable stray current in the supply line 24 is drained away via the control electrode 66 by virtue of the anodic action thereof. On the anode side—that is to say, in region 58—the stray current then no longer drains away in damaging manner via the material of the supply line 24 but, instead of this, drains away via the control electrode 66. By virtue of the catalyst material 68, a catalytic action of the control electrode 66 is obtained that favors the electrochemical decomposition of the water into oxygen and protons. By virtue of the fact that the control electrode extends markedly into the interior of the insulating section 38—in the example, approximately between approximately 50% and 60% of the axial extent thereof—the stray current now drains away on the anodic side in region 58 via the control electrode 66. Moreover, the catalytic coating with the catalyst material 68 favors the formation of oxygen on the control electrode 66, since the excess voltage for this electrocatalytically desired reaction is lowered in purposeful manner. Since the stray currents are relatively small, the quantities of oxygen arising are really slight and do not impair operation, at least so long as these quantities of oxygen are unable to accumulate in the insulating section 38 or in the adjoining regions 56, 58 of the supply line 24. But in the present case this is ensured, since the excess voltage during the operation of the electrolysis plant 10 the insulating section 38 is flowed through in the interior by water. Region 56 of the supply line 24, which is attached to the cell-supply unit 18 in accordance with FIG. 1, acts cathodically, as a result of which no release of metal ions is to be expected there.

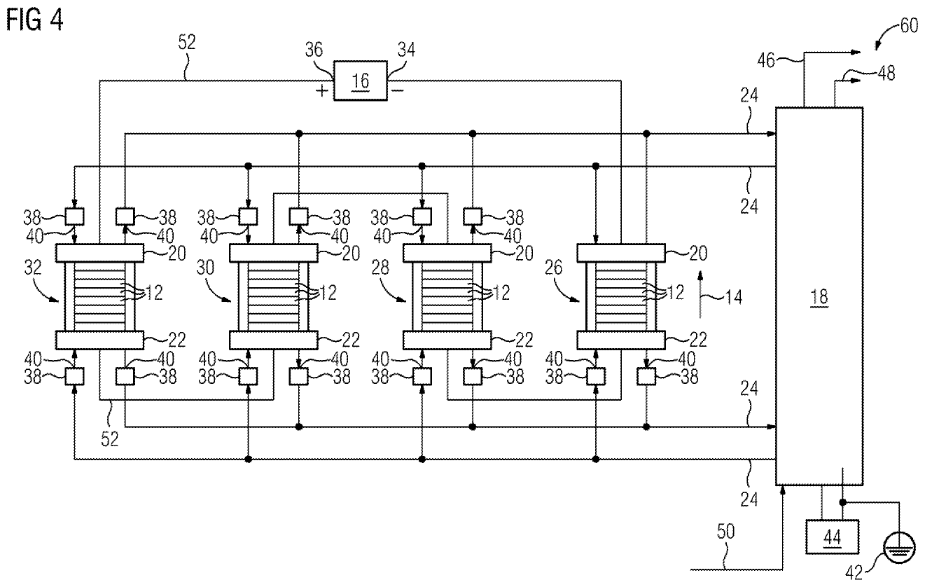

The application of the invention is illustrated in FIG. 4 in a schematic block representation in respect of a further electrolysis plant 60 for electrolyzing water. In this complex electrolysis plant 60, the aforementioned corrosion effect in the region of the insulating section 38, which was elucidated with reference to FIG. 3, is avoided sustainably and very effectively. The following explanatory remarks are also based on the previous explanatory remarks relating to FIGS. 1 and 3, for which reason reference is additionally made to the relevant statements.

As is evident from FIG. 4, the electrolytic cells 12 are arranged in four partial stacks 26, 28, 30, 32. Each of the four partial stacks 26, 28, 30, 32 is connected to the cell-supply unit 18 by means of two first supply lines 24, attached to the cell-supply unit 18 and to a first end 20 of the respective partial stack 26, 28, 30, 32, and by means of two second supply lines 24 attached to the cell-supply unit 18 and to a second end 22, situated opposite the first end 20 in the stacking direction 14, of the respective partial stack 26, 28, 30, 32. The statements relating to FIGS. 1 and 2 apply substantially to the cell-supply unit 18.

The first supply line 24 which is attached to the first end 20 of that partial stack 26 which is coupled with a negative electrical potential 34 of the electrical energy-source 16 is attached in electrically conducting manner to the cell-supply unit 18. As a result, precisely this first end 20 of partial stack 26 is electrically connected directly to the cell-supply unit 18. All the other supply lines 24 exhibit respective electrical insulating sections 38.

In the present case, the invention provides that the number of respective electrolytic cells 12 of the partial stacks 26, 28, 30, 32 is the same for all the partial stacks 26, 28, 30, 32. Depending upon the requirement, in other configurations this may, however, also have been chosen differently, without departing from the idea of the invention.

The partial stacks 26, 28, 30, 32 are, in turn, electrically connected in series, so that—from an electrical point of view—a series circuit of all the electrolytic cells 12 of the partial stacks 26, 28, 30, 32 is again present, as in the case of the cell stack 54 according to FIG. 1.

By virtue of this structural design of the electrolysis plant 60, it can be ensured that the cell-supply unit 18, considered electrically, has the lowest electrical potential of the entire electrolysis plant 60. This electrical potential is furthermore connected to the negative electrical potential 34 of the electrical energy-source 16. The electrical energy-source 16 makes available, in addition, the positive electrical potential 36. Between the negative and the positive electrical potentials 34, 36, the electrical energy-source 16 makes available the operating voltage for the designated operation of the electrolysis plant 60.

In the embodiment shown in FIG. 4, the invention provides that that first supply line 24 which is attached to the first end 20 of that partial stack 26 which is capable of being coupled with a negative electrical potential 34 of the electrical energy-source 16 is attached in electrically conducting manner to the cell-supply unit 18, and all the other supply lines 24 exhibit respective electrical insulating sections 38. Here, all the insulating sections 38 exhibit a respective control electrode 66 protruding at least partially into the interior of the insulating section, which is arranged and configured in accordance with FIG. 3. But, depending upon the corrosion load in the insulating sections 38, it is also possible that not all of the insulating sections 38 but rather a predeterminable plurality of the insulating sections 38 exhibit a respective control electrode 66 protruding at least partially into the interior of the insulating section 38. If need be, this can be designed for the respective operating situation of the electrolysis plant 60.

The invention may furthermore optionally provide that at the insulating-section ends 40, facing toward respective ends 20, 22 of the respective partial stacks 26, 28, 30, 32, of the respective insulating sections 38 an electrical insulating layer, which in the present case is constituted by a coating consisting of an insulating material, has been formed on the inside of the supply line. The insulating material is, for instance, a suitable synthetic substance. Alternatively or additionally, however, a corrosion-resistant metal-containing substance may also have been provided, for instance a metal oxide or the like, in particular a ceramic material, for example.

In addition, the invention may furthermore provide that the respective ends 20, 22 of the partial stacks 26, 28, 30, 32, which face toward the respective insulating sections 38, are designed to be electrically insulated with respect to the electrolytic cells 12. As a result, the corrosion effect can be diminished further. It proves to be particularly advantageous if the cell-supply unit 18 has been electrically grounded by means of a grounding 42 which may have been realized as a direct short circuit to ground or—as represented in FIG. 4—may have been realized indirectly.

In this advantageous realization of the electrolysis plant 60, the invention provides that the grounding 42 is not attached to the cell-supply unit 18 directly but is attached by utilizing a voltage-source 44 by means of which a negative electrical potential with respect to the ground potential is capable of being applied to the cell-supply unit 18. For this purpose, the voltage-source 44 makes available an electrical voltage from approximately −1 V to approximately −0.8 V. In principle, however, this voltage may also have been chosen, for example, within a range from approximately −2 V to approximately 0 volt.

With an electrical voltage that has been set in this manner, the corrosion effect—for instance, in the case of high-grade steel—against corrosion can be suppressed better still even under maritime conditions, for instance in offshore applications.

It proves to be particularly advantageous if the counter-electrode for the cathodic protection against corrosion is then also arranged in the region of the cell-supply unit 18. The electrode provided here for the grounding 42 is constituted in the present case by a titanium anode which has been coated with a mixed oxide. In the present case, the titanium anode with the mixed-oxide coating is arranged to be electrically insulated from the cell-supply unit 18 in a liquid phase of an oxygen-separating vessel which is not represented in any detail.

Overall, the embodiment examples show that with the invention it can be ensured that the corrosion can be diminished by virtue of the fact that several partial stacks 26, 28, 30, 32 of the electrolytic cells 12 can be formed which, moreover, are all electrically connected in series but are connected to the cell-supply unit 18 separately via their own supply lines 24.

Through the purposeful use of the control electrode 66 in the insulating section 38 of the supply line 24 of the electrolysis plant 60, the formation and therefore the release of metal ions can already be largely prevented. The application of this effective corrosion-protection concept is capable of being flexibly adapted, for instance to various plant-engineering configurations of PEM electrolysis plants. Consequently the undesirable corrosion can be largely avoided. It proves to be a particular advantage that even complex electrolysis plants 60 with several partial stacks 26, 28, 30, 32 and with respective attachments to the supply line 24 for the supply of operating substances are capable of being operated with only one central electrical energy-source 16 (DC source) and with a central cell-supply unit 18. As described, a cathodic protection against corrosion is possible as an additional and advantageous measure.

The invention is by no means restricted only to the application in connection with the electrolysis of water, and may equally come into operation also in connection with other electrolysis processes to be carried out, for instance electrolysis of carbon dioxide or the like.

The embodiment examples serve exclusively for elucidation of the invention and are not intended to restrict it.

1. An electrolysis plant comprising:
a plurality of electrolytic cells which are electrically connected in series and which are at least partially arranged successively in a stacking direction, wherein the series circuit is capable of being electrically coupled with an electrical energy-source;
a cell-supply unit for supplying the electrolytic cells with at least one operating substance for designated operation; and
supply lines attached to the cell-supply unit and to opposing ends of the successively arranged electrolytic cells, wherein a material of the supply lines features metal, and
wherein at least one of the supply lines exhibits an electrical insulating section with a control electrode, protruding into the interior of the electrical insulating section, with a catalyst material, which is electrically contacted with a metallic pipe section of the supply line on the anodic side thereof.

2. The electrolysis plant as claimed in claim 1, in which the control electrode protrudes between 30% and 70%, preferentially approximately 40% to 60%, into the interior of the insulating section in the axial direction, measured from the anodic side of the insulating section.

3. The electrolysis plant as claimed in claim 1, characterized in that the electrolytic cells are arranged in at least two partial stacks, wherein each of the at least two partial stacks is connected to the cell-supply unit by means of at least one first supply line, attached to the cell-supply unit and to a first end of the respective partial stack, and by means of at least one second supply line attached to the cell-supply unit and to a second end, situated opposite the first end in the stacking direction, of the respective partial stack, wherein that first supply line which is attached to the first end of that partial stack which is capable of being coupled with a negative electrical potential of the electrical energy-source is attached in electrically conducting manner to the cell-supply unit, and all the other supply lines exhibit respective electrical insulating sections, wherein a plurality of the insulating sections exhibit a respective control electrode protruding into the interior of the insulating section.

4. The electrolysis plant as claimed in claim 1, characterized in that the control electrode is arranged in such a manner that during designated operation when the operating substance is being supplied a stray current in the supply line is capable of being drained away via the control electrode by virtue of the anodic action thereof.

5. The electrolysis plant as claimed in claim 1, characterized in that the control electrode is configured in wire-like, rod-like or grid-like manner.

6. The electrolysis plant as claimed in claim 1, characterized in that the control electrode exhibits a carrier metal of high conductivity, in particular titanium, coated with the catalyst material.

7. The electrolysis plant as claimed in claim 6, characterized in that the catalyst material exhibits an oxide of a noble metal.

8. The electrolysis plant as claimed in claim 6, characterized in that the catalyst material exhibits a mixed oxide including iridium and/or ruthenium.

9. The electrolysis plant as claimed in claim 1, characterized in that the respective ends, facing toward the respective insulating sections, of the partial stacks are electrically insulated with respect to the electrolytic cells.

10. The electrolysis plant as claimed in claim 1, characterized in that a voltage-source is provided which is attached the cell-supply unit, so that a negative electrical potential with respect to the ground potential is capable of being applied to the cell-supply unit.

11. The electrolysis plant as claimed in claim 10, characterized in that the grounding exhibits a sacrificial anode and/or a voltage-source by means of which a negative electrical potential with respect to the ground potential is capable of being applied to the cell-supply unit.

12. The electrolysis plant as claimed in claim 2, characterized in that the partial stacks are attached to the cell-supply unit in parallel by methods of supply engineering.
